(19) United States
(12) Patent Application Publication
(10) Pub. No.: US 2014/0032224 A1
(43) Pub. Date: Jan. 30, 2014

(54) METHOD OF CONTROLLING ELECTRONIC APPARATUS AND INTERACTIVE SERVER

(71) Applicant: SAMSUNG ELECTRONICS CO., LTD., SUWON-SI (KR)

(72) Inventors: Cheong-jae LEE, Suwon-si (KR); Jung-eun KIM, Seoul (KR); Jin-sik LEE, Suwon-si (KR); Eun-kyoung KIM, Suwon-si (KR)

(73) Assignee: SAMSUNG ELECTRONICS CO., LTD., SUWON-SI (KR)

(21) Appl. No.: 13/952,292

(22) Filed: Jul. 26, 2013

Related U.S. Application Data
(60) Provisional application No. 61/675,987, filed on Jul. 26, 2012.

(51) Int. Cl. G10L 21/06

(52) U.S. Cl. CPC G10L 21/06
USPC 704/275

(57) ABSTRACT

A method of controlling an electronic apparatus is provided. The method includes: inputting a user message; comparing the input user message with stored information; and outputting a response message and one of a plurality of inquiry messages in response to the input user message and based on a result of the comparing, wherein the outputting the one of the plurality of inquiry messages is also based on a plurality of priorities.

### CROSS-REFERENCE TO RELATED APPLICATION(S)

This application claims priority from Korean Patent Application No. ______, filed ______, in the Korean Intellectual Property Office, and from U.S. Provisional Application No. 61/675,987, filed on Jul. 26, 2012, in the United States Patent and Trademark Office, the disclosures of which are incorporated herein by reference in their entirety.

### BACKGROUND

1. Field

Apparatuses and methods consistent with exemplary embodiment relate to providing a method of controlling an electronic apparatus and an interactive server, and more particularly, to providing a method of controlling an electronic apparatus that outputs a response message and an inquiry message according priorities, and an interactive server.

2. Description of Related Art

Various types of electronic apparatuses have been developed and supplied with the development of electronic technologies. In particular, various types of electronic apparatuses, such as smart phones, televisions (TVs), etc., have been increasingly used. Accordingly, the electronic apparatuses have gradually added various functions according to demands of users.

Therefore, various input methods are required to efficiently use various functions of electronic apparatuses. For example, an input method using a remote controller, an input method using a mouse, an input method using a touch pad, etc. have been applied to the electronic apparatuses.

However, it is difficult to effectively use the various functions of the electronic apparatuses only through these input methods. For example, if all the various functions of an electronic apparatus are controlled by only a remote controller, a large number of buttons of the remote controller is required. Accordingly, it is not easy for a general user to learn how to use the remote controller. Similarly, in a method of displaying various types of menus on a screen to allow a user to search for and select a corresponding menu, the user must navigate a complicated menu tree to select a desired menu.

Accordingly, in the related art, technology using a voice recognition has been developed to conveniently and intuitionally control an electronic apparatus. For example, the electronic apparatus receives a voice of a user by using a voice input unit such as a microphone, searches a stored database (DB) for a command corresponding to the voice of the user, and controls the electronic apparatus by using the search result.

However, voice recognition technology of the related art provides only a function corresponding to a voice of a user and does not provide a command that is frequently used by the user. Therefore, the effectiveness of the voice recognition is reduced.

### SUMMARY OF THE INVENTION

Exemplary embodiments address at least the above problems and/or disadvantages and other disadvantages not described above. Also, the exemplary embodiments are not required to overcome the disadvantages described above, and an exemplary embodiment may not overcome any of the problems described above.

One or more exemplary embodiments provide a method of controlling an electric apparatus that outputs a response message with respect to a user message and outputs one inquire message according to priorities based on a result of the response message, and an interactive server.

According to an aspect an exemplary embodiments, there is provided a method of controlling an electronic apparatus. The method may include: inputting a user message; comparing the input user message with stored information; and outputting a response message and one of a plurality of inquiry messages in response to the input user message and based on a result of the comparing, wherein the outputting the one of the plurality of inquiry messages is also based on a plurality of priorities.

The method may further include: storing the additional user message if the additional user message in response to the inquiry message is received.

The plurality of priorities may be calculated based on the additional user message.

The inputting of the user message may include inputting a voice signal of a user.

The user message may be a command to set a schedule of the user.

According to an aspect of another exemplary embodiment, there is provided an interactive server including: a communicator configured to communicate with a user terminal; a storage unit; and a controller configured to control the communicator to, if a user message is input from the user terminal through the communicator, compare the input user message with information stored in the storage unit, generate a response message in response to the user message based on a result of the comparing, generate one of a plurality of inquiry messages based on a plurality of priorities and the generated response message, and transmit the generated one of the plurality of inquiry messages to the user terminal.

If an additional user message in response to the inquiry message is received, the storage unit may store the additional user message.

The plurality of priorities may be calculated based on the additional user message.

The input user message may be a voice signal of a user.

The user message may be a command to set a schedule of the user.

According to an aspect of another exemplary embodiment, there is provided a method of controlling an electronic device to respond to a user message, the method including: comparing the user message with stored information; determining whether there is a conflict between the user message and the stored information based on a result of the comparing; outputting at least one of a plurality of response messages based a result of the determining; and outputting at least one of a plurality of inquiry messages based on a user preference if it is determined that a conflict exists.

Each of the plurality of inquiry messages may have a corresponding priority based on the user preference.

The method may further include updating the priority of the at least one of the plurality of inquiry messages based on an additional user message.

The at least one of the plurality of inquiry messages may be sequentially generated based on their corresponding priority, beginning with the inquiry message having a highest corresponding priority.

The additional user message may be a voice signal of a user.

The user message may be a voice signal of the user.

The user message may be a command to set a schedule of the user.

The comparing may include comparing a time the user message with at least one time of the stored information.

The determining may include determining there is a conflict when the time of the user message is the same as the at least one time of the stored information.

### BRIEF DESCRIPTION OF THE DRAWINGS

The above and/or other aspects will be more apparent by describing certain exemplary embodiments with reference to the accompanying drawings, in which:

FIG. 1 is a view illustrating a control system according to an exemplary embodiment;

FIG. 2 is a block diagram of an electronic apparatus according to an exemplary embodiment;

FIG. 3 is a block diagram of an interactive server according to an exemplary embodiment;

FIG. 4 is a flowchart illustrating a control method according to an exemplary embodiment;

FIG. 5 is a flowchart illustrating the control method of FIG. 4 in further detail;

FIGS. 6 through 9 are views illustrating an operation of a control system according to an exemplary embodiment; and

FIG. 10 is a flowchart illustrating an operation of an interactive server according to an exemplary embodiment.

### DETAILED DESCRIPTION OF THE INVENTION

Certain exemplary embodiments are described in greater detail with reference to the accompanying drawings.

In the following description, like drawing reference numerals are used for the same elements, even in different drawings. The matters defined in the description, such as detailed construction and elements, are provided to assist in a comprehensive understanding of the exemplary embodiments. However, exemplary embodiments can be practiced without those specifically defined matters. Also, well-known functions or constructions are not described in detail since they would obscure the exemplary embodiments with unnecessary detail.

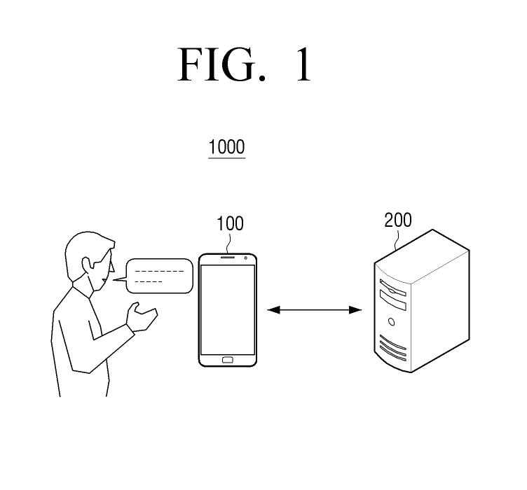

FIG. 1 is a view illustrating a control system 1000 according to an exemplary embodiment.

Referring to FIG. 1, the control system 1000 includes an electronic apparatus 100 and a server 200.

The electronic apparatus 100 receives a user message from a user and outputs a response message in response to the user message. In this case, the electronic apparatus 100 may output one of a plurality of inquiry messages according to priorities based on a result of the response message. Here, the electronic apparatus 100 may be a portable phone such as a smart phone, but this is only exemplary. Therefore, the electronic apparatus 100 may be realized as various types of apparatuses such as a portable phone, a TV, a desktop personal computer (PC), a notebook PC, a navigation system, a tablet PC, etc.

The server 200 receives the user message from the electronic apparatus 100 and transmits a response message corresponding to the user message to the electronic apparatus 100. In this case, the server 200 may be an interactive server but is not limited thereto.

In detail, the electronic apparatus 100 receives the user message from the user, converts the user message into a signal that may be processed by the electronic apparatus 100 and the server 200, and transmits the signal to the server 200. In this case, the user message may be input into the electronic apparatus 100 through a voice of the user, but this is only exemplary. The user message may be input through various types of other input means such as a keyboard, a mouse, a touch pen, a touch screen, etc. The server 200 receives the converted signal and transmits a signal to a response message about the converted signal to the electronic apparatus 100, and the electronic apparatus 100 may convert the signal into a format that may be recognized by the user and output the signal. For example, the format of the signal may be a voice format and/ or a text format.

The server 200 may store the signal received from the electronic apparatus 100. In this case, the server 200 may store a response message preferred by the user. Therefore, the server 200 may transmit an inquiry message preferred by the user according to the received user message. This will be described in further detail later.

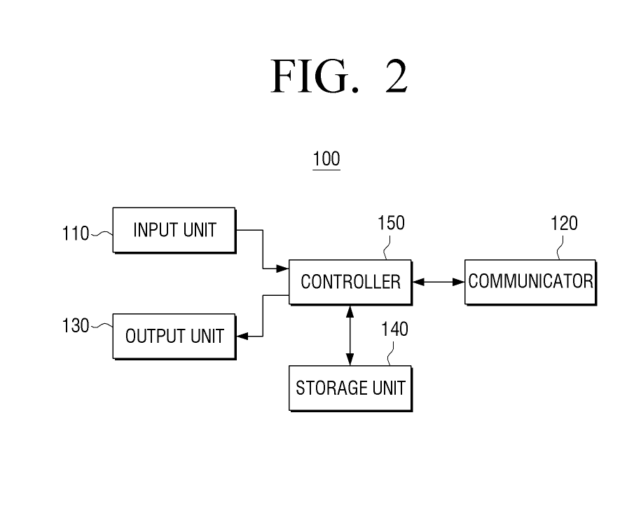

FIG. 2 is a block diagram of the electronic apparatus 100, according to an exemplary embodiment.

Referring to FIG. 2, the electronic apparatus 100 includes an input unit 110, a communicator 120, an output unit 130, a storage unit 140, and a controller 150.

The input unit 110 receives a user message from a user and converts the user message into a message signal using the controller 150. In this case, the user message may be a voice signal of the user, and the message signal may be an electrical signal into which a voice signal is converted. For example, if the input unit 110 inputs a user message: “Make an appointment at 1 PM today,” the input unit 110 may convert the user message into a message signal such as: “theme=set schedule and date=June, 31 and time=13 o'clock and object=appointment.”

The controller 150 transmits the message signal to the communicator 120, and the communicator 120 transmits the message signal to the server 200. The communicator 120 receives a response message and/or inquiry message to the message signal from the server 200 and transmits the response message and/or inquire message to the controller 150. The controller 150 transmits the response message and/or inquiry message to the output unit 130.

The output 130 outputs the response message and/or inquiry message, which are received from the server 200, to the user. In this case, the response message and/or inquiry message may be output in at least one of voice and text formats. Accordingly, the output unit 130 may include a speaker and display unit. In detail, the display unit may be realized as a liquid crystal display (LCD), an organic light-emitting diode (OLED), a plasma display panel (PDP), or the like to provide various types of screens that may be provided through the electronic apparatus 100. In particular, the display unit may display a response message corresponding to the voice of the user in a text or image format.

The storage unit 140 may be a realized as a storage medium, e.g., a memory, a hard disk drive (HDD), or the like, that stores various types of programs necessary for operating the electronic apparatus 100. For example, the storage unit 140 may include a read only memory (ROM) that stores a program for performing an operation of the controller 150, a random access memory (RAM) that temporarily stores data acquired according to a performance of the operation of the controller 150, etc. The storage unit 140 may further include an electrically erasable and programmable ROM (EEROM) that stores various types of reference data.

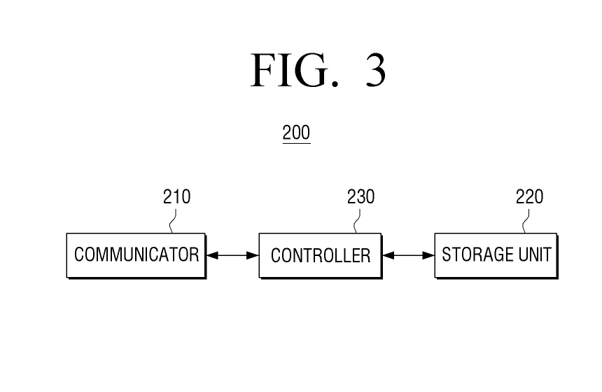

FIG. 3 is a block diagram of an interactive server 200, according to an exemplary embodiment.

Referring to FIG. 3, the interactive server 200 includes a communicator 210, a controller 230, and a storage unit 220.

The communicator 210 communicates with the electronic apparatus 100. In detail, the communicator 210 may receive a user message from the electronic apparatus 100 and transmit a response message and/or inquiry message corresponding to the user message to the electronic apparatus 100. Accordingly, the communicator 210 may include various types of communication modules.

The storage unit 220 stores a record of a conversation with the user. In detail, the storage unit 220 stores the user message and information corresponding to the user message. The stored information includes a response message, an inquiry message, and an additional user message corresponding to the user message. For example, if the user message is a command to set a schedule, the response message may be an acceptable response or unacceptable response to the command to set the schedule. The inquiry message may be an inquiry about whether the schedule has been set at another time, an inquiry about whether all schedules of a corresponding date have been suggested, an inquiry about whether presetting of a schedule has been cancelled, or the like. The additional user message may be a response message that is input by the user with respect to one of a plurality of inquiry messages. However, the user message, the response message, the inquiry message, and the additional user message are only examples and thus there may be various types of other messages. The storage unit 220 may be a relational database (DB) or a Non-Structured Query Language (SQL) memory DB (e.g., a NoSQL memory DB).

The controller 230 controls an overall operation of the interactive server 200. In detail, if the user message is received from the electronic apparatus 100, the controller 230 may control the communicator 210 to generate a response message and/or inquiry message corresponding to the user message and transmit the response message and/or inquiry message to the electronic apparatus 100. If the additional user message to the inquiry message is received from the electronic apparatus 100, the controller 230 may control the communicator 210 to perform processing with respect to the additional user message.

In particular, the controller 230 may control the communicator 210 to transmit the response message and/or inquiry message to the electronic apparatus 100 based on the record of the conversation in the storage unit 220. For example, if the user message is a command to set a new schedule that is not stored in the storage unit 220, the controller 230 may control the communicator 210 to transmit a response message accepting the user message to the electronic apparatus 100. In this case, since the response message accepting the user message is generated, the controller 230 may control the communicator 210 not to generate the inquiry message. In other words, the controller 230 may control the communicator 210 to transmit a response message: “Yes. The schedule has been set” to the electronic apparatus 100. However, if the user message is a command to set the same schedule as that stored in the storage unit 220, the controller 230 may control the communicator 210 to transmit a response message indicating that the user message is not accepted, to the electronic apparatus 100. In this case, since the response message indicating that the user message is not accepted is generated, the controller 230 may control the communicator 210 to generate an inquiry message. In other words, the controller 230 may control the communicator 210 to generate a response message: “The schedule may not be set,” and an inquiry message: “Do you want to know another time?”, “Do you want to know a schedule of that day?”, or “Do you want to cancel the stored schedule?” The controller 230 may control the communicator 210 to transmit the response message and/or inquiry message to the electronic apparatus 100.

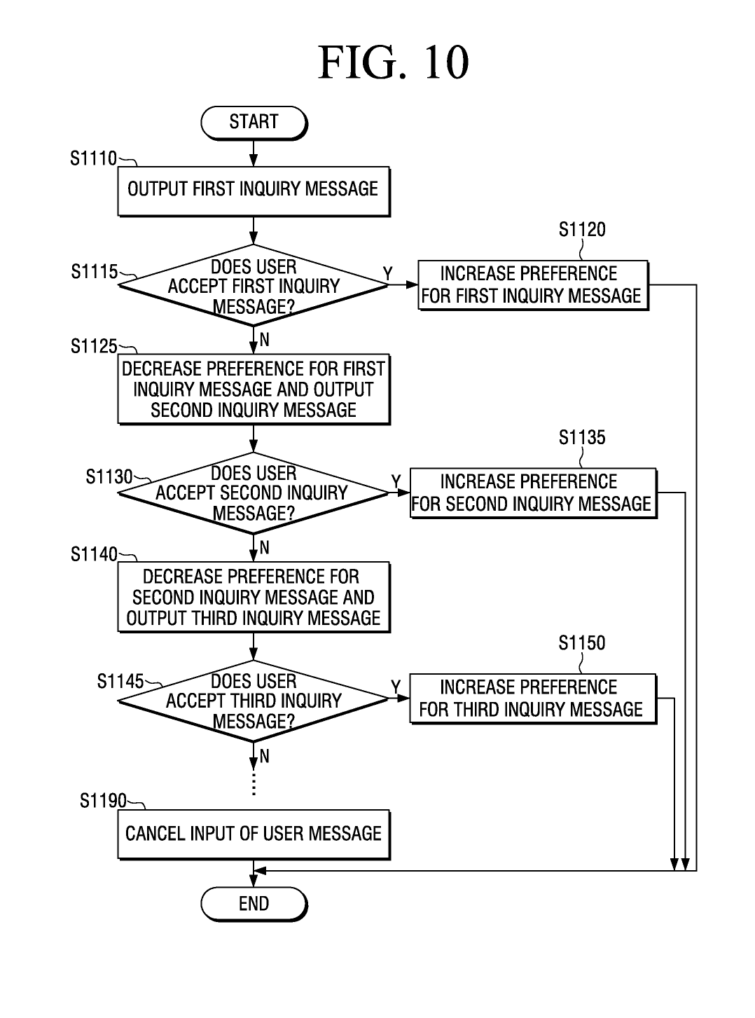

The controller 230 may control the communicator 210 to transmit the inquiry message in order of preferences of the user. In detail, if the inquiry message is generated, the controller 230 may control the communicator 210 to transmit the inquiry message to the electronic apparatus 100 according to the order of preferences of the user. In this case, the preference for the inquiry message may be determined based on the additional user message of the user in response to the inquiry message. The user message, the response message to the user message, and the additional user message to the response message may be stored in the storage unit 220. This will be described in further detail later with reference to FIG. 10.

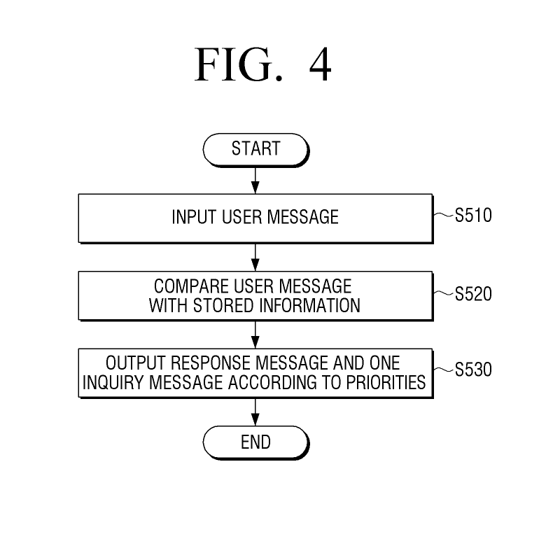

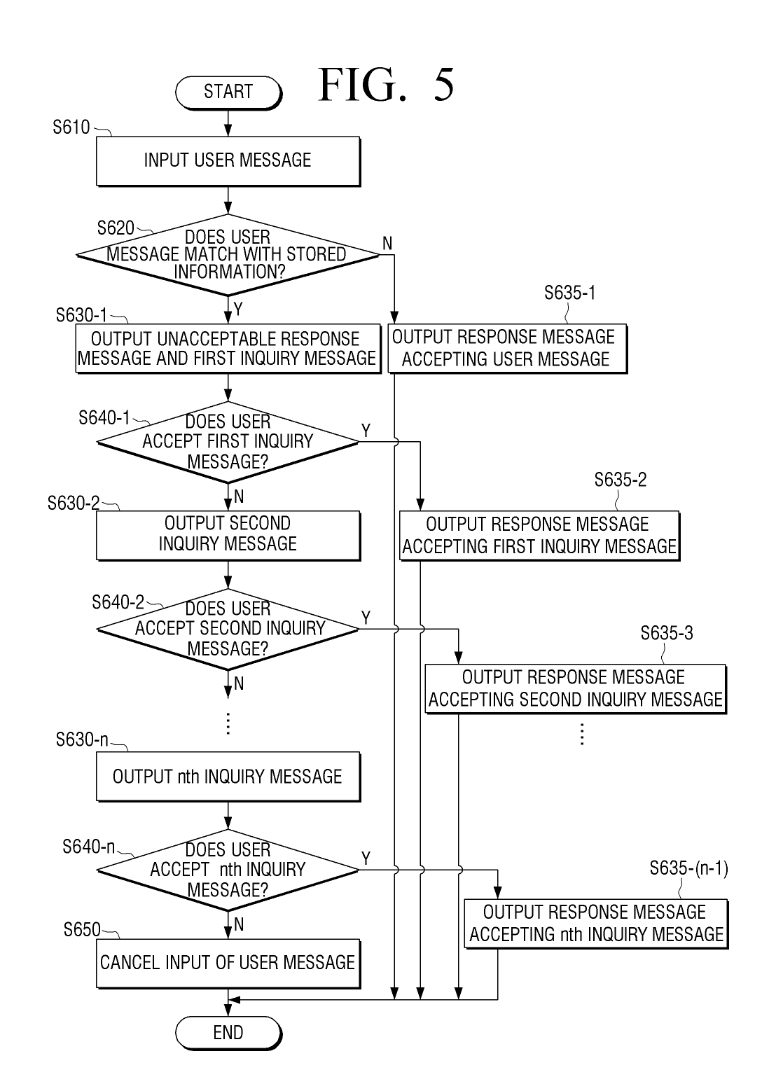

FIG. 4 is a flowchart illustrating a control method according to an exemplary embodiment. FIG. 5 is a flowchart illustrating the control method of FIG. 4 in detail. A method of controlling the electronic apparatus 100 will now be described with reference to FIGS. 4 and 5.

As shown in FIG. 4, the control method according to the present exemplary embodiment includes: inputting a user message; comparing the input user message with stored information; and outputting a response message and an inquiry message according to priorities.

In operation S510, the electronic apparatus 100 receives a user message. In this case, the electronic apparatus 100 may be realized as various types of apparatuses such as a portable phone, a TV, a desktop PC, a notebook PC, a navigation system, a tablet PC, etc. The electronic apparatus 100 may receive the user message, which is a voice signal, through a microphone. However, this is only exemplary, and thus the user message may be input through various types of means such as a keyboard, a mouse, a touch pen, a touch screen, etc. The input user message may be converted into a signal that may be recognized by the electronic apparatus 100 and the interactive server 200. Therefore, the input user message may be transmitted and/or received and controlled as the converted signal by the electronic apparatus 100 and the interactive server 200 and may be referred to as a user message for convenience of description herein.

The electronic apparatus 100 transmits the input user message to the server 200. In this case, the electronic apparatus 100 and the interactive server 200 may be connected to each other through a communication network. There may be one or more communication networks connecting the electronic apparatus 100 and the interactive server 200. Additionally, the electronic apparatus 100 and the interactive server 200 may share various types of communication networks.

In operation S520, the interactive server 200 receives the user message from the electronic apparatus 100 and compares the user message with stored information. If the user message is acceptable based on the stored information, the interactive server 200 generates a response message accepting the user message. However, if the user message is unacceptable based on the stored information, the interactive server 200 generates a response message indicating that the user message is unacceptable. In this case, the interactive server 200 may generate an inquiry message along with the response message indicating that the user message is unacceptable. The inquiry message may be a message that is related to the user message to request a response from the user and may be pre-stored in the server 200. The inquiry message may be generated according to order of preferences of the user. In other words, inquiry messages may be generated in order of a plurality of inquiry messages selected the most by the user.

In operation S530, the interactive server 200 transmits the response message and/or inquiry message to the electronic apparatus 100, and the electronic apparatus 100 outputs the response message and/or inquiry message. In this case, the electronic apparatus 100 may output the response message and/or inquiry message through a speaker and/or a display panel. The control method will now be described in further detail with reference to FIG. 5.

FIG. 5 is a flowchart illustrating the control method of FIG. 4 in further detail.

Referring to FIG. 5, in operation S610, the electronic apparatus 100 receives a user message from a user. As described above, the user message is transmitted to the interactive server 200 through a communication network.

In operation S620, the interactive server 200 that has received the user message determines whether the user message matches with stored information. In other words, if the user message does not match with the stored information in operation S620, the interactive server 200 generates and outputs a response message accepting the user message in operation S635-1.

For example, if the user message is: “Make an appointment with a friend at 1 PM today,” and the stored information is: “The appointment with the friend has been set at 5 PM today,” the user message is acceptable. Therefore, the interactive server 200 may generate the response message: “Yes. The appointment with the friend has been set at 1 PM today,” accepting the user message.

If the user message matches with the stored information in operation S620, the interactive server 200 generates and outputs a response message not accepting the user message and one of a plurality of inquiry messages in operation S630-1. If the stored information is: “The office appointment has been set at 1 PM today,” the user message is unacceptable. Therefore, the interactive server 200 may generate a response message: “The schedule may not be set” that does not accept the user message or a response message: “No. The office picnic has already been set at 1 PM today.” Simultaneously, the interactive server 200 may generate an inquiry message that prompts the user to input another user message. Therefore, the interactive server 200 may generate one of a plurality of inquiry messages such as: “Do you want to know another settable time?”, “Do you want to know a schedule of that day?”, “Do you want to cancel a stored schedule?”, etc. The response message and the inquiry message may be pre-stored in the interactive server 200. In particular, the inquiry message may be generated according to the order of preferences of the user.

If the user accepts a first inquiry message in operation S640-1, the interactive server 200 outputs a response message accepting the first inquiry message in operation S635-2. In the previous exemplary embodiment, if a user message: “Yes” is input with respect to a first inquiry message: “Do you want to know another settable time?”, the interactive server 200 may generate and output a response message: “Today's settable times are 11 AM, 3 PM, and 7 PM,” in operation S635-2.

If the user does not accept the first inquiry message in operation S640-1, the interactive server 200 may generate and output a second inquiry message in operation S630-2. In the previous exemplary embodiment, if a user message: “No” is input with respect to the first inquiry message: “Do you want to know another settable time?”, the interactive server 200 may generate and output a second inquiry message: “If then, do you want to know a schedule of that day?”

If the user accepts the second inquiry message in operation S640-2, the interactive server 200 may output a response message accepting the second inquiry message in operation S635-3. However, if the user does not accept the second inquiry message in operation S640-2, the interactive server 200 may generate and output a third inquiry message.

If the number of inquiry messages pre-stored in the interactive server 200 is n, the interactive server 200 generate and output an n^{th} inquiry message in operation S630-n. If the user accepts the n^{th} inquire message in operation S640-n, the interactive server 200 generates and outputs a response message accepting the n^{th} inquiry message in operation S635-(n-1). If the user does not accept the nth inquiry message in operation S640-n, the interactive server 200 generates and outputs a response message indicating that the input of the user message is to be cancelled in operation S650.

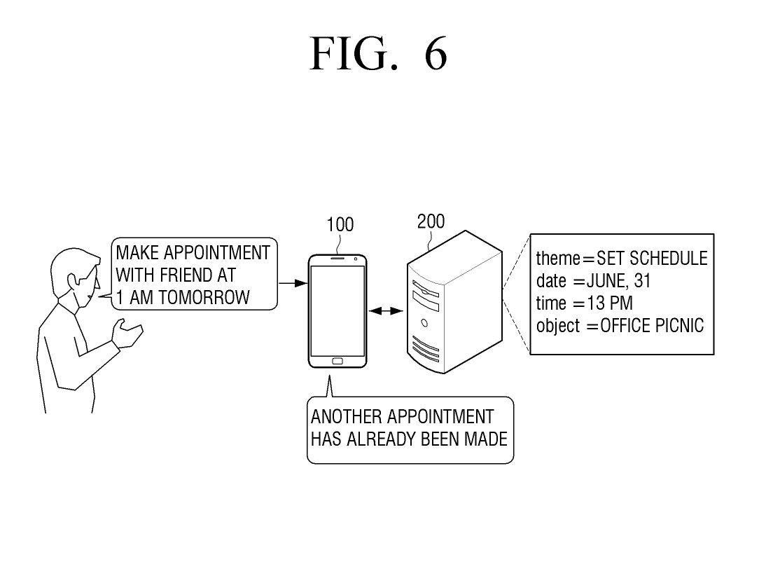

FIGS. 6 through 9 are views illustrating an operation of a control system according to an exemplary embodiment.

As shown in FIG. 6, a user inputs a user message: “Make an appointment with a friend at 1 PM tomorrow” into the electronic apparatus 100. The electronic apparatus 100 that has input the user message transmits the user message to the interactive server 200. Since another appointment is already set at the same date and the same time and pre-stored in the interactive server 200 before receiving the user message, the user message is unacceptable. Therefore, the interactive server 20 transmits a response message indicating that the user message is unacceptable, to the electronic apparatus 100, and the electronic apparatus 100 receives the response message and outputs the response message as a signal: “Another appointment has been set,” that may be recognized by the user. In this case, the response message may be output as a voice signal through a speaker or may be output an image signal or a text signal through a display panel.

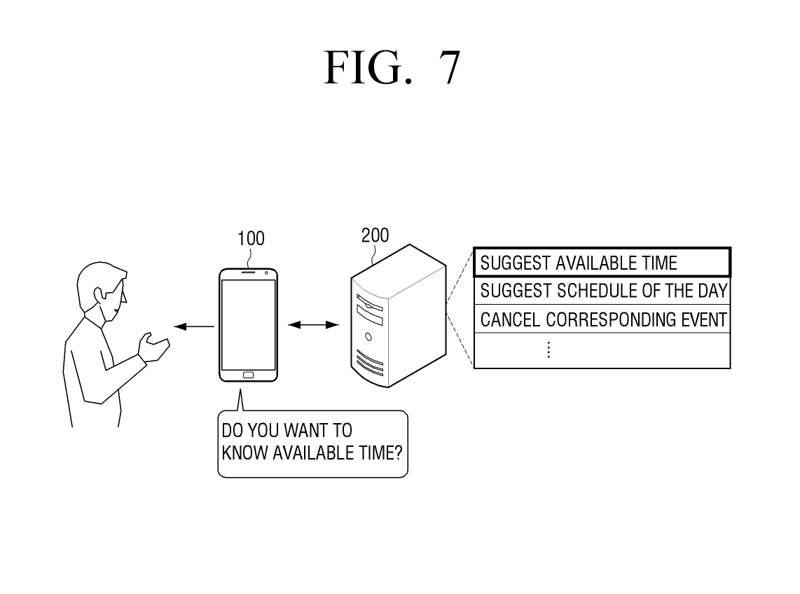

Referring to FIG. 7, a plurality of inquiry messages are stored in the interactive server 200. In this case, the plurality of inquiry messages may have priorities according to preferences of the user, and inquiry messages having high priorities may be generated and output before inquiry messages having low priorities. The priorities of the inquiry messages will be described in further detail later with reference to FIG. 10. In FIG. 7, the inquiry message: “Suggest an available time,” among the plurality of inquiry messages has the top priority, and priorities are set in order of an inquiry message: “Suggest a schedule of the day,” an inquiry message: “Cancel a corresponding event,” etc. Therefore, in the present exemplary embodiment, since the user message is unacceptable, the electronic apparatus 100 may receive a first inquiry message: “Do you want to know an available time?” having a top priority from the interactive server 200 and output the first inquiry message.

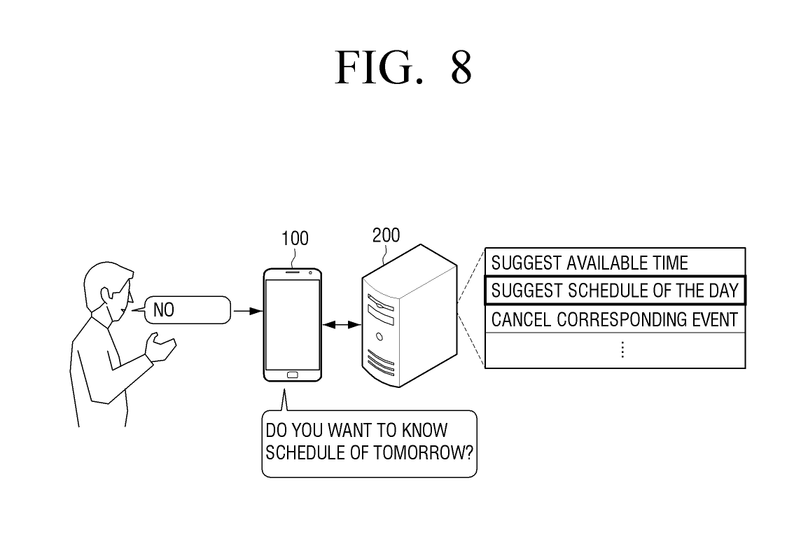

Referring to FIG. 8, the user inputs a response message: “No” to the first inquiry message to input a first additional user message not accepting the first inquiry message into the electronic apparatus 100. The electronic apparatus 100 that has input the first additional user message transmits the first additional user message to the interactive server 200. The interactive server 200 does not perform processing with respect to the first inquiry message according to the first additional user message, and generates and outputs a second inquiry message. In this case, the second inquiry message is an inquiry message having a priority one step lower than the first inquiry message. Therefore, the electronic apparatus 100 may receive a second inquiry message: “If then, do you want to know a schedule of tomorrow?” from the interactive server 200 and output the second inquiry message.

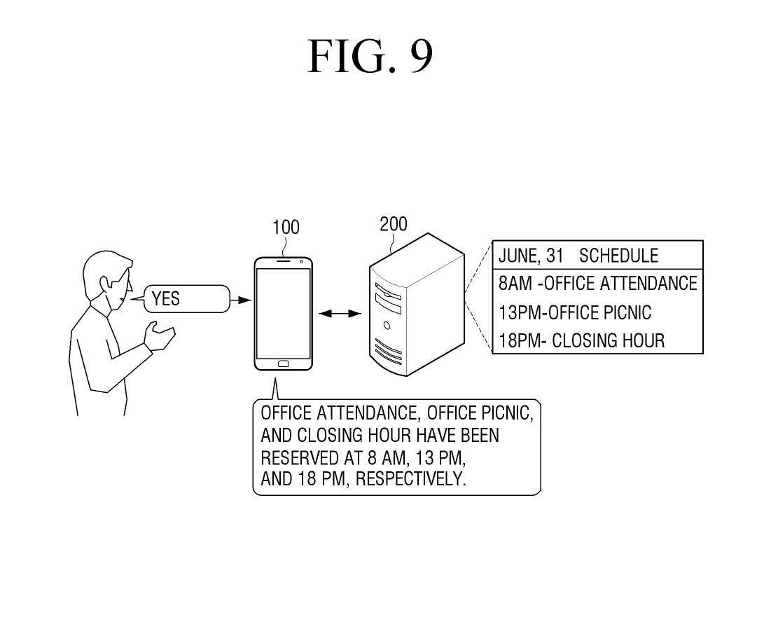

Referring to FIG. 9, the user inputs a response message: “Yes” to the second inquiry message to input a second additional user message accepting the second inquiry message into the electronic apparatus 100. The electronic apparatus 100 transmits the second additional user message to the server 200. The interactive server 200 performs processing with respect to the second inquiry message according to the second additional user message to output a response message indicating that processing is performed with respect to the second inquiry message. In other words, the interactive server 200 may output a response message: “An office attendance has been reserved at 8 AM tomorrow, an office picnic has been reserved at 1 PM tomorrow, and a closing hour has been reserved at 6 PM tomorrow.”

FIG. 10 is a flowchart illustrating an operation of the interactive server 200, according to an exemplary embodiment. A method of setting priorities according to preferences for a plurality of inquiry messages will now be described.

A plurality of inquiry messages may be pre-stored in the interactive server 200. Also, a user message may be set as an inquiry message. For example, if a user message: “Let me know another available appointment time” is input into the interactive server 200, the interactive server 200 may change the user message into an inquiry message and store the user message as an inquiry message: “Do you want to know another available appointment time?”

Referring to FIG. 10, in operation S1110, the interactive server 200 outputs a first inquiry message that is one of the plurality of inquiry messages. If a user accepts the first inquiry message in operation S1115, a preference for the first inquiry message increases in operation S1120. However, if the user does not accept the first inquiry message in operation S1115, the preference for the first inquiry message decreases in operation S1125.

If the user does not accept the first inquiry message, the interactive server 200 outputs a second inquiry message in operation S1125. If the user accepts the second inquiry message in operation S1130, a preference for the second inquiry message increases in operation S1135. However, if the user does not accept the second inquiry message in operation S1130, the preference for the second inquiry message decreases in operation S1140.

If the user does not accept the second inquiry message, the interactive server 200 outputs a third inquiry message in operation S1140. Here, the user may accept or may not accept the second inquiry message. In this case, the preference for the second inquiry message may increase or decrease according to the same method as that described above. Also, a preference for an n^{th} inquiry message may also increase or decrease according to the same method as that described above.

According to this method, preferences for inquiry messages may be calculated, and thus priorities of the inquiry messages may be determined. Also, a plurality of inquiry messages, which respectively has priorities at a time when the user message is input, may be sequentially output to the user.

If a user does not accept any of the inquiry messages stored in the interactive server 200, the interactive server 200 outputs a response message indicating that an input of the user message is to be canceled in operation S1190.

According to the various exemplary embodiments described above, a personalized service may be provided to a user, and thus convenience of the user may be improved.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of controlling an electronic apparatus, the method comprising:
inputting a user message;
comparing the input user message with stored information; and
outputting a response message and one of a plurality of inquiry messages in response to the input user message and based on a result of the comparing,
wherein the outputting the one of the plurality of inquiry messages is also based on a plurality of priorities.

2. The method of claim 1, further comprising storing an additional user message, if the additional user message in response to the inquiry message is received.

3. The method of claim 2, wherein the plurality of priorities are calculated based on at least the additional user message.

4. The method of claim 1, wherein the inputting of the user message comprises inputting a voice signal of a user.

5. The method of claim 1, wherein the user message is a command to set a schedule of the user.

6. An interactive server comprising:
a communicator configured to communicate with a user terminal;
a storage unit; and
a controller configured to control the communicator to, if a user message is input from the user terminal through the communicator, compare the input user message with information stored in the storage unit, generate a response message in response to the user message based on a result of the comparing, generate one of a plurality of inquiry messages based on a plurality of priorities and the generated response message, and transmit the generated one of the plurality of inquiry messages to the user terminal.

7. The interactive server of claim 6, wherein if an additional user message in response to the inquiry message is received, the storage unit stores the additional user message.

8. The interactive server of claim 7, wherein the plurality of priorities are calculated based on at least the additional user message.

9. The interactive server of claim 6, wherein the input user message is a voice signal of a user.

10. The interactive server of claim 6, wherein the user message is a command to set a schedule of the user.

11. A method of controlling an electronic device to respond to a user message, the method comprising:
comparing the user message with stored information;
determining whether there is a conflict between the user message and the stored information based on a result of the comparing;
outputting at least one of a plurality of response messages based a result of the determining; and
outputting at least one of a plurality of inquiry messages based on a user preference if it is determined that a conflict exists.

12. The method of claim 11, wherein each of the plurality of inquiry messages have a corresponding priority based on the user preference.

13. The method of claim 12, further comprising updating the priority of the at least one of the plurality of inquiry messages based on an additional user message.

14. The method of claim 13, wherein the at least one of the plurality of inquiry messages are sequentially generated based on their corresponding priority, beginning with the inquiry message having a highest corresponding priority.

15. The method of claim 13, wherein the additional user message is a voice signal of a user.

16. The method of claim 11, wherein the user message is a voice signal of the user.

17. The method of claim 11, wherein the user message is a command to set a schedule of the user.

18. The method of claim 17, wherein the comparing comprises comparing a time of the user message with at least one time of the stored information.

19. The method of claim 18, wherein the determining comprises determining there is a conflict when the time of the user message is the same as the at least one time of the stored information.
